(19) United States
(12) Patent Application Publication
(10) Pub. No.: US 2016/0225011 A1
(43) Pub. Date: Aug. 4, 2016

(54) SELECTING THE BEST CARD FOR A PURCHASE

(71) Applicant: MasterCard International Incorporated, Purchase, NY (US)

(72) Inventors: Akshit Mukesh Shah, Santa Clara, CA (US); Priyank Pradip Gandhi, Sunnyvale, CA (US); Pankaj R. Dubey, San Jose, CA (US); Saravana Perumal Shanmugam, Fremont, CA (US)

(21) Appl. No.: 14/610,639

(22) Filed: Jan. 30, 2015

(51) Int. Cl. G06Q 30/02; G06Q 20/34; G06Q 20/22

(52) U.S. Cl. CPC G06Q 30/0238; G06Q 30/0207; G06Q 20/227; G06Q 20/34

(57) ABSTRACT

The present disclosure tracks purchases and rewards for users of credit cards, debit cards or other trackable accounts. When a user is ready to purchase an item, such as an item at a retail store, a terminal at the store contacts a system for information concerning credit cards, debit cards and other accounts of the person. Information at the store discloses the category of the item and the price. The system then calculates potential rewards to the user, depending on the card or other account used to pay for the item. The user or the clerk at the store can then select a card or other account to pay for the item, e.g., a credit card or an account of the user with the store or seller of the item. A similar method can be used when purchasing on line, obtaining the price and checking for rewards.

### FIELD

The present disclosure is generally related to consumer comparison shopping and analysis.

### BACKGROUND

In today's competitive world, sellers of goods and services seek to take advantage of opportunities to increase their sales, advance their market share, and achieve greater profitability. This also applies to service industries, especially the financial service industries. Examples of financial service firms include a variety of financial institutions, including banks, savings and loan associations, credit card companies, debit card companies, travel service companies that specialize in financial services, and the like. In order to advance the interests of these companies, a great variety of “rewards” are now offered. These “rewards” are offered by sellers of goods and services. Examples from the recent past include “stamps” offered by merchants and presented to grocery store shoppers in hopes of inspiring consumer loyalty. These “stamps” have been replaced by coupons or other discounts at grocery stores or other “brick and mortar” venues. Airlines have long offered “frequent flyer miles” or other incentives to keep users returning to the same airline.

A new type of reward has arisen, not from the merchant of the goods or services, but from the financial services industry, as the financial services industry helps the buyer to pay for the good or service that is desired. There are many examples of such rewards, e.g., a credit card or debit card that tracks one's purchases and offers a “1% cash back reward” for all purchases made with the card. The cash back may not be offered instantly, but the accumulated reward appears on the user's monthly statement as a cash reward that may be used as the person desires. Other “rewards” or perquisites may be offered. These may be “points” for spending so much on certain categories of purchases, e.g., groceries, fuel, travel, sports, entertainment, restaurants, and so forth. It may not be clear to the user of a credit card, debit card or other financial instrument exactly who is offering the reward, e.g., the credit card company or the bank that issues the credit card. For purposes of this disclosure, a credit card company or a debit card company refers to the card network or to the bank or other financial institution that issues the card.

Still other financial services, such as credit cards, debit cards and the like, may offer frequent flyer miles, discounts on future purchases, hotel points, insurance for renting a rental car or for a durable goods item purchased, a longer guarantee or warranty for a durable goods item purchased, and so on. There is such a variety of rewards and reward programs that it is very difficult for a consumer to keep track of possible rewards, let alone try to evaluate which reward may be the most desirable for a given purchase the consumer is considering. The present disclosure shows how the rewards may be tracked and evaluated to overcome this difficulty.

### SUMMARY

A first embodiment is a method for tracking rewards available for a purchase. The method includes steps of accepting with at least one computer a request from a user to find a product or a service and in response to the request, conducting a search with the at least one computer for the product or the service. The method includes steps of storing a result of the search for the product or the service, accepting a request with the at least one computer for a search for rewards for purchasing the product or the service, the rewards provided by at least one of: a seller of the product or the service, a credit card company, and a debit card company, and then presenting results of the search for rewards to the user. The result may be stored in volatile memory or non-volatile memory.

Another embodiment is also a method for tracking rewards available for a purchase. The method includes steps of accepting with at least one computer a request to find a product or a service, and in response to the request, conducting a search with the at least one computer for the product or the service and for a price for the product or the service. The method then includes steps of storing a result of the search, conducting with the at least one computer a search for rewards for purchasing the product or the service, the rewards provided by at least one of: a seller of the product or the service; a credit card company; and a debit card company, and presenting the results of the search for rewards. The result may be stored in volatile memory or non-volatile memory.

Another embodiment is also a method for tracking rewards for the person. The method includes steps of accepting with at least one computer a request from a user to find a product or a service and in response to the request, conducting a search with the at least one computer for the product or the service. The method then includes storing a result of the search, conducting with the at least one computer a search for rewards for purchasing the product or service, the rewards provided by at least one of: the seller of the product or the service; and a financial institution through a credit card, and presenting the results of the search for rewards to the user. The result may be stored in volatile memory or non-volatile memory.

In an aspect, a method may include accepting with at least one computer a request from a user to find a product or a service, in response to the request, conducting a search with the at least one computer for the product or the service, storing a result of the search for the product or the service, accepting a request with the at least one computer for a search for rewards for purchasing the product or service, the rewards provided by at least one of: a seller of the product or the service, a credit card company, and a debit card company, and presenting results of the search for rewards to the user. The request may be made at a point-of-sale terminal of the seller. The method may further include notifying the user via a mobile device of the user that the user has an account with the seller or with a third-party service for additional rewards for the product or the service. The method may further include accepting the result of the search for the product or the service and rendering payment through a point-of-sale terminal of the seller. The method may further include accepting payment for the good or the service through a point-of-sale terminal of the seller of the product or the service, the payment rendered using a device selected from the group consisting of a card swipe device of the seller, a near field communication (NFC) reader of the seller, a receiver for receiving communications from a wireless RFID fob of the user and a device for accepting a wireless payment communication from a wireless payment device or mobile device of the user. The method may further include accepting payment via the at least one computer by accepting information of a credit card or a debit card. The result of the search may include a reward offered through a third party marketing firm. The method may further include itemizing with the at least one computer the result of the search for rewards by a reward type, wherein the results of the search include a plurality of types of rewards, at least two of the plurality of types selected from the group consisting of: miles rewards, points rewards, cash back rewards, warranty-type rewards; travel-type rewards; discounts on future purchases from the seller; and insurance-type rewards. The search for the good or the service may be conducted via the at least one computer accessible to a plurality of web sites of a plurality of sellers of the product or the service. The method may further include ranking the result of the search for rewards by a highest reward in at least one category of reward. The result may be stored in volatile memory or non-volatile memory.

In an aspect, a method may include accepting with at least one computer a request to find a product or a service, in response to the request, conducting a search with the at least one computer for the product or the service and for a price for the product or the service, storing a result of the search, accepting with the at least one computer a request for a search for rewards for purchasing the product or the service, the rewards provided by at least one of: a seller of the product or the service, a credit card company and a debit card company, and presenting the result of the search for rewards. The method may further include ranking the results of the search for the product or the service according to a lowest price for the product or the service. The method may further include ranking the results of the search for rewards by a highest reward in a reward category. The method may further include ranking the results of the search for rewards by a highest reward in a reward category selected from the group consisting of: miles rewards, points rewards; travel-type rewards; and cash-back rewards. The method may further include ranking the results of the search for rewards by a combination of two or more types of rewards. The method may further include notifying a user via a mobile device of the user that the user is eligible for a reward from a merchant when the user enters a store of the merchant. The search for rewards may include several searches of merchant, financial institution and credit card company web sites. The at least one computer may include a mobile device of the user, and may further include presenting the results to the mobile device of the user. The at least one computer may include a point-of-sale terminal of a seller of the product of the service. At least one result from the search for rewards may include discounts on future purchases made with the credit card or the debit card. The result may be stored in volatile memory or non-volatile memory.

In an aspect, a method may include accepting with at least one computer a request from a user to find a product or a service, in response to the request, conducting a search with the at least one computer for the product or the service, storing a result of the search for the product or the service, conducting with the at least one computer a search for rewards for purchasing the product or the service, the rewards provided by at least one of: the seller of the product or the service and a credit card company, and presenting results of the search for rewards to the user. The method may further include presenting to the user at least one reward level or threshold that will be achieved depending on the credit card used by the user to purchase the product or the service. The method may further include presenting to the user a reward level or balance in at least two of: an account of the user with the seller of the product or the service; and credit card accounts of the user. The method may further include ranking at least one of the results of the search for the price for the product or the service to the user, or ranking the results of the search for rewards for purchasing the product or the service. The rewards may be selected from the group consisting of miles rewards, points rewards, cash back rewards, warranty-type rewards, travel-type rewards; discounts on future purchases from the seller, and insurance-type rewards. The method may further include accepting a request via the at least one computer to a third party service to determine whether rewards are available for purchasing the product or the service. The results of the search for rewards may include a concierge service or access to a travel assistance service. The results of the search may include a reward offered through a third party marketing firm. The seller of the product or the service may offer the rewards for the purchasing the product or the service through an account or a private label credit card of the seller. The result may be stored in volatile memory or non-volatile memory.

This disclosure includes a number of embodiments, and is intended to be descriptive of any number of embodiments, rather than limiting.

### BRIEF DESCRIPTION OF THE DRAWINGS

FIG. 1 depicts a system useful for operations and for communicating between the parties involved in offering and awarding rewards;

FIG. 2 depicts a table useful for tracking or evaluating the discount and rewards offered for a given purchase of a good or a service;

FIG. 3 depicts the user presented cards or account and the rewards accumulated to date;

FIG. 4 depicts the rewards balances for the user's accounts if the purchase is made using each of the user's accounts or cards;

FIG. 5 depicts the next threshold in the user's accounts if the user makes the contemplated purchase using each of the user's accounts or cards;

FIG. 6 depicts a first comparison of discounts and rewards among a user's cards or accounts;

FIG. 7 depicts a second comparison of discounts and rewards for a user; and

FIGS. 8-10 are flowcharts for several methods for practicing this disclosure.

### DETAILED DESCRIPTION

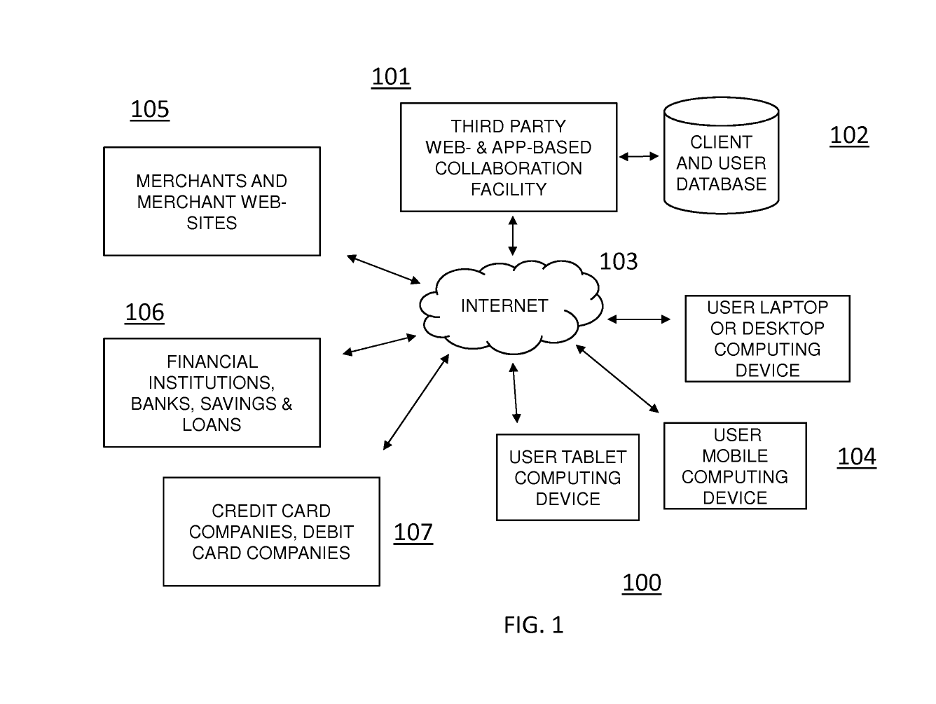

The present disclosure concerns a system and a method for helping consumers obtain the best rewards, offers, or other incentives possible from among a plurality of programs the consumer belongs to and available offers or incentives. In order to maximize the rewards, offers, or other incentives, the user must first track the rewards, offers, or other incentives and keep abreast of what rewards, offers, or other incentives have been earned and what rewards, offers, or other incentives are possible from each contemplated purchase. With different denominated rewards/offers/incentives (e.g. miles accrued, cash back, discount, etc.), it can be difficult to keep track of the available rewards/offers/incentives and determine the most favorable of those. A system to aid in the selection of a financial instrument to use in a contemplated transaction based on the most favorable reward, offer, or incentive is illustrated in FIG. 1, which depicts a system 100 for tracking the rewards, offers, or other incentives.

Rewards, offers, or other incentives may be tracked using a third party web-based facility 101. The facility 101 may have a database 102 for tracking and storing information about the user's rewards. The database may also include information about clients of the facility, e.g., merchants or others who may wish to use the marketing services of the third party. The facility may also be application based, i.e., it may be useful to have an application on the user's computer or mobile device to assist in tracking and presenting earned and potential rewards to the user or card-member. The facility may store in its database 102 information about each consumer's programs and rewards. The facility may also store information on what is offered by each of the user's reward programs for a variety of possible purchases. In some embodiments, the user may have aggregated their reward program/credit card/financial instruments through a universal payment facility or digital smart card (e.g. Plastc, Coin, Apple Pay, MasterPass). This information may be accessed through the database 102, accessed through an API to receive exported underlying information, and the like. The exported underlying information can be complete card information, categories of rewards, offers, or incentives available, a unique identifier, and the like.

For example, one program, credit card, or other payment method of the user may offer rewards, offers, or other incentives that vary according to a category of the merchandise or service that is offered. For example, a cash-back rewards program may offer 3% cash back for restaurant or entertainment services, 2% cash back for groceries, and 1% back for fuel purchases. Another program or credit card of the user may offer no cash back, but may award points at a rate of one point for each $1.00 or $0.10 of a purchase for select merchandise or services. Other programs may offer special incentives for various purchases. In one example, a credit card company may have an agreement with merchants to offer a longer warranty for an item purchased with their credit card. In another example, a credit card company may have an agreement with rental car companies to cover insurance for lessees (renters) of the cars, allowing the lessee to avoid the extra expense of paying for insurance when he or she rents a car and pays with a particular credit card. Many other examples of rewards, offers, and incentives are possible.

Devices 104 of the user may include a user laptop or desktop computing device, a user tablet computing device, or a mobile computing device, such as a wireless telephone, personal digital assistant, or similar. The user devices may connect with the third party facility through the internet 103 for web-based applications. Alternatively, the third party facility may offer applications for a user to download onto a device, or a mobile device, of the user. With updated information and an application (“App”) on the user's phone, it may not be necessary to contact the third party facility for each contemplated or possible purchase. The app may instantly provide the calculations, as discussed herein, and guide the user to the optimal choice for paying for the purchase. The application on the user's cell device may be periodically updated with the latest information and status on the various rewards programs in order to yield an accurate answer as to which card or account to use for the contemplated purchase or service.

In embodiments, applications used in the system may integrate directly, such as via API, with rewards or points bank systems like MasterCard Rewards and may also integrate directly with personalized offers systems. In embodiments, applications and aspects of the system may integrate into an online store, such as by using a browser plugin or direct integration with the retailer. The integration with the retailer may be Javascript or API integration at the checkout page. In embodiments, applications and aspects of the system may integrate at the physical store, such as through POS terminal integration, the card authorization flow, the payment gateway of the acquirer, or in-store mobile payment application through API.

In other instances, the user may connect directly with the third party facility through other paths, e.g., those used by standard cellular communications or other radio-frequency applications. It is also possible for communication to take place via a hot spot of the merchant or seller in the store or retail outlet of the merchant, using a network of the merchant or seller to connect through the internet to the third party facility 101.

Also, connecting to the third party facility may be a variety of merchants and merchant web sites 105 and financial institutions 106, such as banks and savings and loan associations. Merchants and web sites of merchants may also have rewards or incentive programs available, whether or not a physical card is used. Thus, a nationwide department store may offer customers an unsecured credit account in the name of the customer, but without issuing a card. In these cases, when a user wishes to make a purchase, a clerk may request a telephone number or other identifier to verify that the user is a member, and upon verification of the phone number or identifier, the user becomes entitled to all benefits, rewards, incentives, and so forth that a member is afforded, without involvement of a card. The person's account with the merchant is sufficient.

Credit card companies and debit card companies or other alternative payment facilitation systems and methods (e.g. Paypal, Bitcoin, etc.) 107 may also desirably keep in touch with the facility 101 in order to constantly update their offers and incentives and keep all portions of the facility up-to-date on their offerings. In this way, when a user at a retailer or an on-line portal wishes to track his or her rewards, offers, or other incentives and potential rewards, the system is instantly able to furnish a record of the user's earned rewards, offers, or other incentives and what the rewards, offers, or other incentives will be when a contemplated purchase is consummated. It may also be advantageous for individual merchants, or their websites or agents, to keep in touch with the facility, by continually updating their programs and data, and the account balances of their members who sign up or join the rewards program with the third party facility.

When a user wishes to make a purchase, the user may be on-line or at a physical retail store. The principles of the present disclosure remain the same in both instances. The information about the user's programs has been gathered and stored in the database 102 and is available when the user wishes to make a purchase. In one example, the user presents a clerk at a retail store with an item for purchase. The user identifies himself or herself, using a store account number, a phone number used by the store account, or some other way, such as by swiping a debit card or a credit card, inputting alternative payment facilitation information, or scanning an EMV card or an RFID chip or fob, or the like. This identifies the user so that the user's rewards, offers, or other incentives may be checked. The clerk then scans a bar code or other indicia of the article. The retail store's computer system then searches for a price for the item and displays the price to the user on a retail or point-of-sale terminal of the retail store. With the price known, the system now searches for the user's rewards, offers, or other incentive to see which rewards, offers, or other incentive the user can apply from the user's rewards, offers, or other incentive programs. If the user is on-line, and the user has logged in to an account of an on-line retailer, the user will be known to the merchant/seller, and the earlier step of identifying the user may not be necessary.

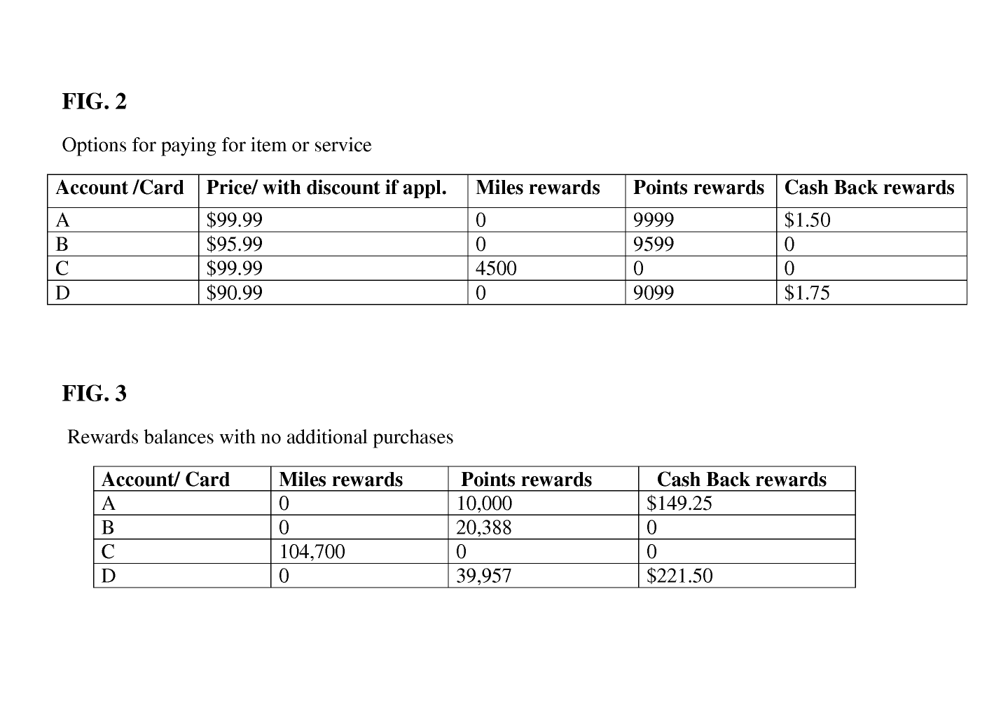

When the store's computer system has searched for the user's rewards, information may be retrieved as shown in the example of FIG. 2. Alternatively, the search may occur in an on-line situation or may occur in an application-based situation on the user's mobile device, such as the user's smart phone, tablet computer or even the user's home computer. As shown in the example of FIG. 2, the rewards categories are listed in the top row and the user's accounts or credit cards are shown in the left-hand column. Thus the second row, row A, may represent the user's account at a national retail store, a restaurant, an airline or other merchant or provider or seller. In this example, the store's computer has searched for and returned a price for an item the user wishes to purchase, the price being $99.99. The system has also determined that if the card or account A is used, that rewards possible are 0 (zero) miles rewards, 9999 points and $1.50 in cash back rewards. The most likely scenario here is that card or account A offers no discounts or miles rewards, but does offer points and cash back rewards. The value of the rewards for account A in this example is $1.50 and the value of 9999 points earned. In this example, the rewards are not either/or, but both—the user earns both points and the cash back reward.

Continuing with the example of FIG. 2, the user's second card is for account or card B. With this account or card, the user receives no miles reward and no cash back reward, but does receive a $4.00 discount and 9599 rewards points. The user here also receives two awards, the immediate discount on the purchase price and 9599 rewards points. The value of the rewards is thus $4.00 and the value of the 9599 rewards. Continuing with this simple example, the rewards possible from account or card A may be better or less good than the rewards possible from account/card B. For card A, the value is $1.50 plus 9999 points. For card B, the value is $4.00 and 9599 points.

Note also that each of the cards or accounts offers only specific rewards, not necessarily all the rewards. In the examples of FIGS. 2-4, card or account A offers only points or cash back rewards; card or account B offers discounts and points, but not miles or cash back. Card or account C offers only miles, not a discount, no points and no cash back. Card or account D offers a substantial discount, in this case, and also points and cash back.

Continuing to row 4 for account or card C, there is no discount for the purchase price, and C offers no points rewards or cash back rewards. The reward available to the user for using card or account C is 4500 rewards miles, only, with no other rewards or discounts. The user may compare the rewards miles to the other available rewards and decide which reward he or she prefers. The value of the rewards for card or account C may not be valued so highly by the user—unless the user is looking for a few more miles to reach a rewards threshold with the airline whose points/miles are offered as the reward.

It may be easier for a user to decide if the user has a little more information about the rewards or miles or points, offers, or other incentives in each of the user's account. A first example is to show the current rewards, available offers, or other incentive balances for each of the user's accounts. FIG. 2 shows the user's accounts as they are before the user contemplates any additional purchases. FIG. 2 does not include any information about a contemplated purchase, only information about the user's current rewards, offers, or other incentive balances. This situation changes if the user considers a purchase and wants information on which card or account to use to make the purchase.

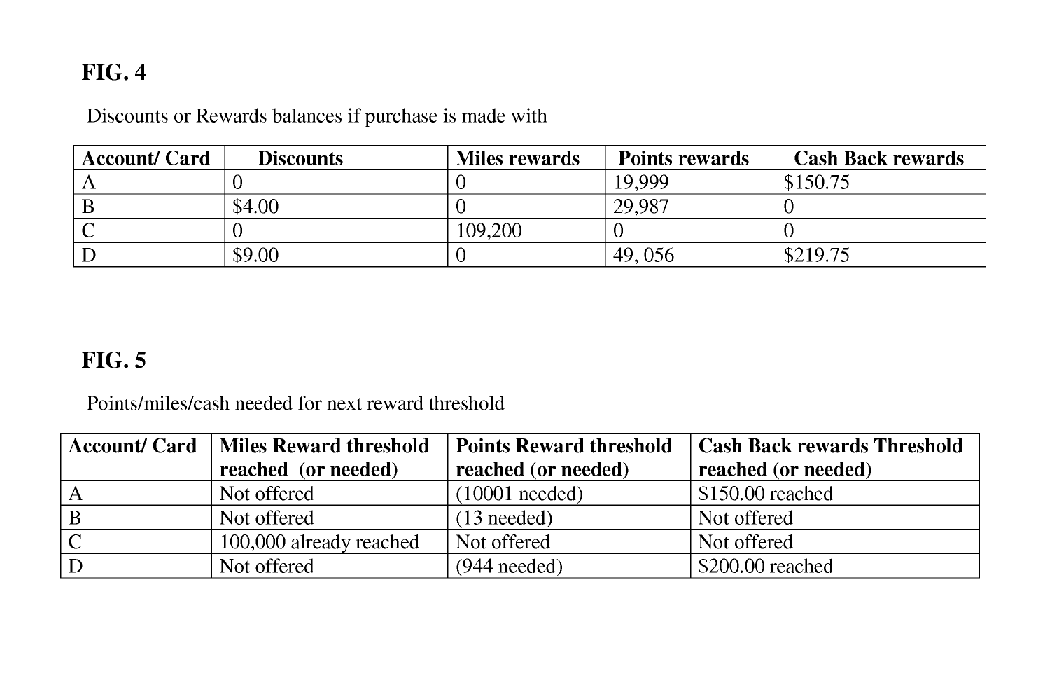

An example of this kind of information is depicted in FIG. 4, which displays the price discounts for the contemplated purchase as well as the rewards balances in the user's various accounts. FIG. 4 depicts the situation in which the rewards are tallied to show the totals if each card or account is used to make the purchase. FIG. 4 shows the available price discount for the item of interest, for any discount available under cards A, B, C and D. The remainder of the columns show the rewards balances for the user if the purchase is made with the A, B, C or D card, respectively. The user will reach these rewards balances only for the card or account used for the purchase. Thus, the reward totals for the cards depicted in FIG. 4 are somewhat inflated, since only one purchase is contemplated and thus only one card or account will reach this level. In another embodiment, a user may prefer to see his or her rewards balance as they are without consideration of the additional purchase, as shown in FIG. 3.

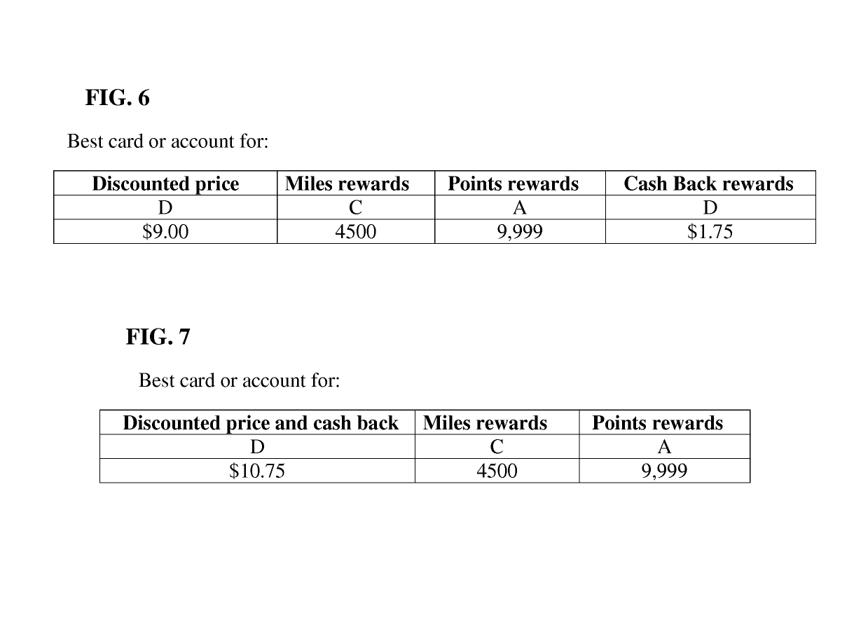

Another technique that may be useful to the user is depicted in FIG. 5. In this example, the user wishes only to see how he or she is doing to achieve the next threshold for each particular rewards, offers, or other incentive program. The price of the merchandise is not shown in FIG. 5. In this instance, the user is enticed by seeing how close he or she is to the next threshold for eligibility for a particular reward. If card or account A is used for the purchase, the user will receive 9999 rewards point (see FIG. 2). That will raise the rewards points total for card A to 19999 (see FIG. 4), leaving the user 10001 points short of the next threshold (see FIG. 5). The threshold in this case is 30,000 points. At the same time, the user will be eligible for $1.50 cash back (see FIG. 2), raising the cash back total to $150.75 (see FIG. 4). This places the user above the $150.00 threshold needed for the next cash back level (see FIG. 5). In one embodiment, the cash back rewards increases each time another $50 increment is reached, e.g., $50, $100, and so forth.

The calculation or comparisons may also be made for the other cards or accounts. For card or account B, there is a $4 discount in the purchase price, and eligibility for 9599 rewards points (see FIG. 2). If card or account B is used, the user will have 29,987 rewards points (see FIG. 4). According to FIG. 4, this will place the user within 13 points of the next threshold for rewards points, which is also 30,000 points. This may encourage the user to use Card or account B, in order to cross the threshold and reach the 30,000 rewards points threshold.

For card or account C, the user can receive only miles rewards. In this case, the user may earn 4500 frequent-flyer miles by using card C for the purchase. This will raise the user's miles rewards to 109,200 (FIG. 4), which is already above the 100,000 miles required for a reward (FIG. 5). Car or account D offers a price discount, rewards points and cash back. By using Card D, the user receives a $9.00 discount on the purchase price, 9099 points rewards and $1.75 cash back reward. Receiving the 9099 points will put the user only 944 points away from the 50,000 points needed for the next reward. Using card D will also keep the user earning cash back; the user has passed the $200 level and needs to get to $250 for the next cash back increment. The user may feel that the rewards offered for the use of card or account D are sufficient to encourage the user to use card or account D.

In addition to the rewards, offers, or other incentives and perquisites discussed above, there are many other rewards possible, including rewards that are possible with a variety of credit or debit cards, or with loyalty plans from the merchant or provider. An example is hotel rewards. Users may choose from a variety of programs that offer rewards, such as Starwood® points, Hilton® HHonors® points, Loews® hotel rewards and the like. In one example, a hotel chain may offer a $25 meal credit for each night spent in the hotel; in addition, there may be a free night's stay offered after a user stays and pays for a given duration. This information may be added to the user's App database and to the third party facility database. Using promotions with airlines or other travel-related services, the benefits and rewards may accumulate. The present application helps users to manage their accounts so that they can maximize the awards earned.

It may be easier for the user to pay attention to rewards, offers, or other incentives by using the services of the third party marketing company. In some embodiments, the user can join such a program at no charge, and input information about the user's rewards, offers, or other incentive programs. The third party marketer can then keep track of the user's rewards, offers, or other incentives and the user may check on his or her rewards, offers, or other incentive levels and availability by simply logging in and checking. The third party marketer can then inform the user of any promotions or campaigns that the marketer feels may benefit the user, based on the user's spending patterns and history, or remind the user of those rewards, offers or incentives already available and perhaps selected by the user or otherwise shown to have an interest by the user. In order to encourage the user, the third party marketer may itself offer rewards, offers, or other incentives for purchases by the user. For example, the third party marketer may have an arrangement with a preferred credit card company and higher rewards may be offered for purchases made during a particular window of time, or with certain preferred sellers, or for purchases in certain preferred categories during that period of time. Alternatively, the third party marketer may arrange with a preferred merchant, e.g., an airline or a hotel chain, to enhance rewards during a promotion if a certain credit card or debit card is used for purchases. In another embodiment, the rewards may be enhanced by offering an additional reward not typically offered by the credit card company. In one example, if a credit card company typically rewards its users with rewards points, it may offer frequent flyer miles if airline travel purchases are made during a period of time, in addition to the rewards points.

The user, as discussed, is able to review the balances and rewards, offers, or other incentives possible in the various accounts and cards of which the user is a member. Instead of the exercise depicted for FIGS. 3-4 of calculating the rewards, it would be easier if the third party facility or the App discussed above could perform these calculations and present a result, or a series of results, so that the user would be better able to decide which card or account to use to make the purchase. As noted above, there are many criteria because there are many possible rewards, offers, or other incentives for the user to consider. A first attempt at comparison is shown in FIG. 6, which depicts a maximization of each column from FIG. 2. The greatest discount or cash back is calculated, along with the greatest miles or points rewards. Thus, a visual comparison of the prices in FIG. 2 shows that the lowest price is the price using the discount afforded the user under card or account D, a price of $90.99. This price is $9.00 lower than the highest price, evidently the list price, the $99.99 price under accounts or cards A and C. Thus, the lowest price offers a $9.00 savings using card or account D.

Only card or account C offers rewards miles in this example, so the highest possible miles reward would be card C's 4500 miles. All cards or accounts here offer rewards points, and the highest reward is from Card A, 9,999 rewards points. Finally, in this example, Cards A and D offer cash back, with Card D's $1.75 greater than Card A's $1.50. Therefore, the greatest cash back reward comes from Card D, $1.75. The table in FIG. 6 displays all the results for each category of reward. In other examples, there may be different rewards offered and the table of rewards shown in FIG. 2 will be different, showing more or different rewards, and the best card or account for a particular reward category, as shown in FIG. 6, will also be different.

FIG. 6 represents a first comparison of rewards, looking at all rewards in a given category and seeing which one is the greatest, i.e., the highest discount, the most miles or points, and so forth. A second attempt at comparison is shown in FIG. 7, merging the categories which are most easily compared, the cash discount and the cash back reward. In the example of FIG. 7, there is no change in the card or account offering the miles or points rewards, and the best card or account remains unchanged, card C and Card A. Card D offered both the best discount on price, $9.00 and $1.75 cash back, for a total of $10.75. The comparison for best discounted price and cash back involves two other cards or accounts. Card A offers $1.50 cash back but no discount, and card B offers a $4.00 discount but no cash back. These are smaller than the total $10.75 offered by Card D, so the greatest discount+cash back reward is that of Card D. As shown in FIG. 7, the user now may pick from among Cards A, B and C, depending on which reward the user feels is the best.

An arithmetic formula or algorithm can easily calculate a table such as FIG. 6 or FIG. 7. The formula or algorithm can easily be designed as the user wishes, for instance to maximize the points earned, to maximize the points earned and cash back, or to take advantage of an offer presented by the third party facility if one of the cards or accounts is used. One way for a person to manage his or her accounts according to the present disclosure is to choose which rewards the person considers the most valuable. In one embodiment, the person may decide that for all purchases, the cash back feature is the most valuable reward. This user then instructs the App or the third party server to maximize the cash back reward for all purchases, in order to help the user select which card or account to use.

In one embodiment, the person may decide to select a different maximization for each vendor or merchant, or for each category of purchases. In another embodiment, the user may decide to maximize a particular kind of rewards points, e.g., MasterCard® rewards points, Visa® MyPoints® or Sears® reward points, for all purchases, though this may limit the user to a single type of reward, unless the user has more than one card or account in the same category. In another example, a user may instruct the App or the third party facility to consider all extended warranty perks or rewards for all purchases involving certain categories of merchandise, e.g., kitchen appliances, laundry appliances and cleaning appliances. In another embodiment, the App or the facility may be instructed to compare the available no-cost warranties that are available depending on which card or account the user selects. In another embodiment, the system may compare and select the warranty that offers the greatest value to the consumer. This may be the warranty with the longest term, the most extensive coverage, the quickest service guarantee, and so forth. The system may then present a single “best” warranty to the user, or may present a table with a comparison of the features available from each card or account. In one embodiment, the “best” warranty may be highlighted, labeled, marked in bold, or otherwise noted for easy viewing by the user.

In another example, the user may instead wish to consider insurance perks or rewards whenever the user contemplates renting a car. Thus, the App or third party facility may be instructed to compare available no-cost insurance or very low-cost insurance from the user's various cards or accounts whenever the user contemplates renting a car, or for example, when a user contemplates a transaction at vendors named Hertz®, Avis®, Penske®, Budget Rent-a-Car® and the like. Thus, when the user queries the App or the third-party facility and the contemplated purchase involves one of these vendors, the App or the facility will automatically use the insurance reward as at least part of the decision-making process. In one example, a table such as FIG. 2, listing the possible rewards, will be presented to the user, with “insurance” as one of the “rewards” and in one embodiment, with terms of the insurance coverage, e.g., a maximum amount of coverage, the different types of coverage (collision, personal injury, death, and so forth), the deductible for each type of coverage, and so forth.

In another example, the merchant in question may have an agreement to prefer one or more credit card networks, e.g., Visa®, MasterCard®, American Express® or Discover®. This information should be available at the point-of-sale in a store, or available on-line when the user contemplates an on-line purchase. A user may approach a clerk or select an object for purchase in an on-line shopping cart. When the user checks out, the clerk or the computer may first check the price, such as to ensure the price is correct. This step may take place at the time of stocking the item and may or may not recur at the time of check-out. When the item is noted, by the clerk or by the system for an on-line check out, a search may be made for rewards possible for the purchase. This may result in a listing of rewards, offers, or other incentives, as shown in FIG. 2, with or without the price of the item.

In embodiments, the value of the offer, reward or incentive may be scaled so that there is a common benchmark. In embodiments, the scaling may be provided by the provider of the offer, reward, or incentive, the host of the system, or the user themselves may provide a desired scaling. For example, all available offers, rewards or incentives may be scaled to a unit of currency, a mileage, points, or the like. An algorithm may be employed to perform the scaling. The algorithm may be controlled through a user interface running on a user's device.

In embodiments, users may optionally input one or more goals, preferences, rules, constraints, limitations, or filters to the system that may be applied in determining which offers, rewards or incentives to present to the user. For example, the user may indicate that a priority goal for them is travel (perhaps even travel to a particular destination). In this example, the rewards, offers or incentives presented may be ranked in accordance with the priority goal such that the rewards, offers or incentives that maximize reaching the travel goal, such as earning enough points to cash in for a ticket to a destination, obtaining a voucher for a hotel at the destination, and the like, are maximized.

When this search is conducted, the merchant's system may also query the third party facility as to whether any other special offers are available. The offer may depend on the identity of the merchant, the identity of the prospective buyer, the nature or category of the merchandise or service contemplated for purchase, the card or account selected and so forth. In one embodiment, the user has a mobile device equipped with a global positioning sensor (GPS) or the user is otherwise able to be tracked or identified. In this embodiment, the user is identified when he or she enters the store, such as through a mobile phone number or other identifier, by launching an app, or the like, and is sent a reminder by the third-party facility to the effect that the user may be eligible for an offer, a reward or other desirable perquisite at the particular store.

This offer or other reward may be displayed separately, without any other actions on the part of the user or the store. If the user is on-line, a similar notification may occur when the user provides identification to the merchant or is identified by cookies or other method available to an on-line merchant. The searches for information and rewards can then take place, and one or more cards selected or presented to the user. A comparison of the cards or accounts may be made, and using one or more criteria, a “best” card or account selected and presented to the user. The criteria, or selection parameters, may include maximum points, maximum frequent flyer miles (also available for non-airline purchases), maximum cash back, maximum purchase price discount, maximum warranty period, available offer(s) already selected and stored by user, soon-to-expire offers, and the like.

In one embodiment, the user may present the item for purchase and use one of his or her credit cards, debit cards, or other account available to the user to pay for a desired purchase. The merchant's system may then conduct the search for the best card or account before transmitting information concerning the purchase to the credit card network or to the financial institution that issues the card. In this embodiment, the merchant's system may contact the third party facility to conduct the search for the best method for payment. In another embodiment, the merchant's system may have a database of rewards for the user and may be able to conduct the search without directly contacting the third party facility. This system is more accurate, of course, if the merchant's system, and database, is updated frequently, e.g., daily, to keep track of the various rewards, points, alerts and other information needed to keep current. If available, the user's offer system may be searched for any available offers already selected and stored by the user (e.g. which they may have forgotten), soon-to-expire offers, or the like.

When the search process is completed, the system may decide that the card presented for purchase is the preferred card and then proceeds with the transaction. In another embodiment, the system may decide that even though Card A was presented for payment, different Card D is better, for any of the reasons discussed above. The user may then be asked to present Card D to the clerk, to enter the information for Card D online in order to proceed with the transaction, to authorize proceeding with the transaction, or the transaction may simply proceed automatically immediately after the system selects a card without any further action on the part of the user.

There are many ways to pay for one's purchase besides entering information through one's computer or mobile device, or swiping a credit card through a point-of-sale (POS) terminal. A user may present a card with an EMV chip, which need not be swiped through a card reader, but need only approach the POS terminal to be read. The user may also render payment using an RFID fob or a near field communication (NFC) device, such as a user's smart phone, wearable computing device, or the like, each for interacting with a suitable reader of the seller. The user's smart phone may be equipped with MasterCard® PayPass®, with payWave® from Visa®, Apple Pay, and the like and used as an NFC device to pay a merchant with a suitable reader. Other contactless payments may be made using secure SIM cards with applications such as Google® Wallet®, for the user's mobile device. There are many other suitable, compatible systems.

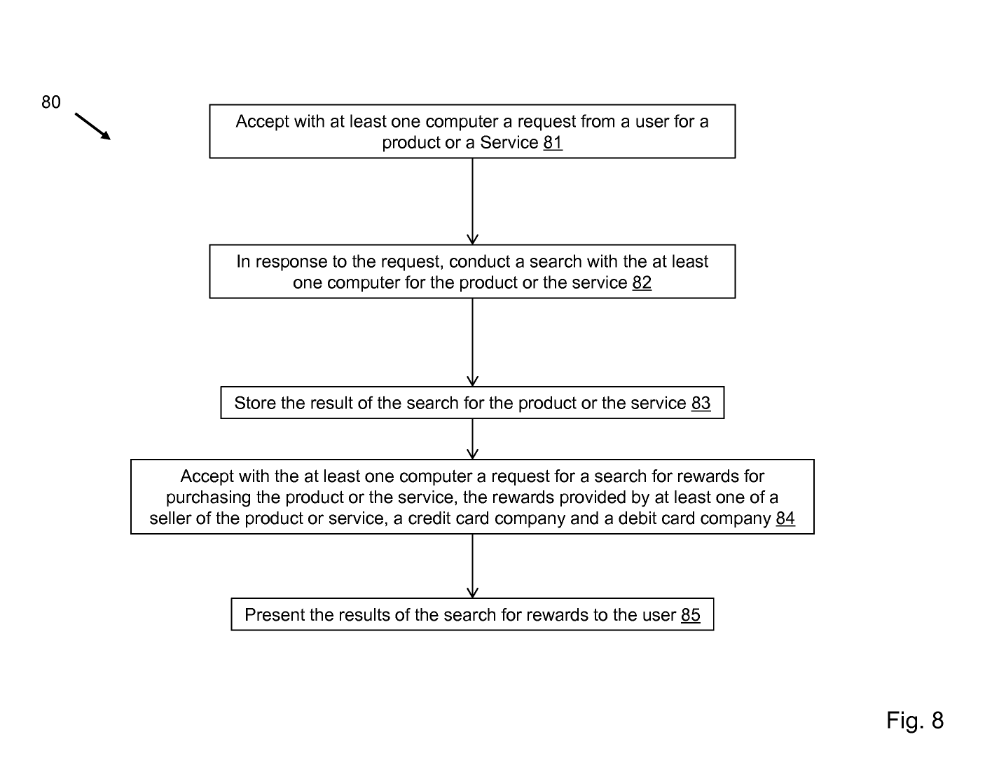

As disclosed, there are many ways to use the present disclosure. A few of the ways may be depicted in flowcharts for methods of practicing the present disclosure. As shown in the flowchart 80 of FIG. 8, one way to begin a method is to accept 81 with at least one computer a request for a price for a product or a service. In response to the request, the system may conduct 82 a search with the at least one computer for the product or the service, find the price for the product or the service and store 83 the result of the search. One may then conduct 84 with the at least one computer a search for rewards, offers, or other incentive for purchasing the product or the service, the rewards provided through at least one of the seller of the product or the service and a financial service company, such as a credit card or debit card company. The results of the search may then be presented 85 to the user. In these figures, and in the claims, it is understood that the “user” may be the person contemplating purchasing the product or the service. In some instances, however, if the user is at a physical store and a clerk is assisting the person, the results of the search may be presented to the clerk, e.g., on the store's point-of-sale terminal, so that the clerk can assist the person in making the decision of which card or account to use. The clerk may then relay the results to the user or cause the user to view a POS or other screen displaying the results.

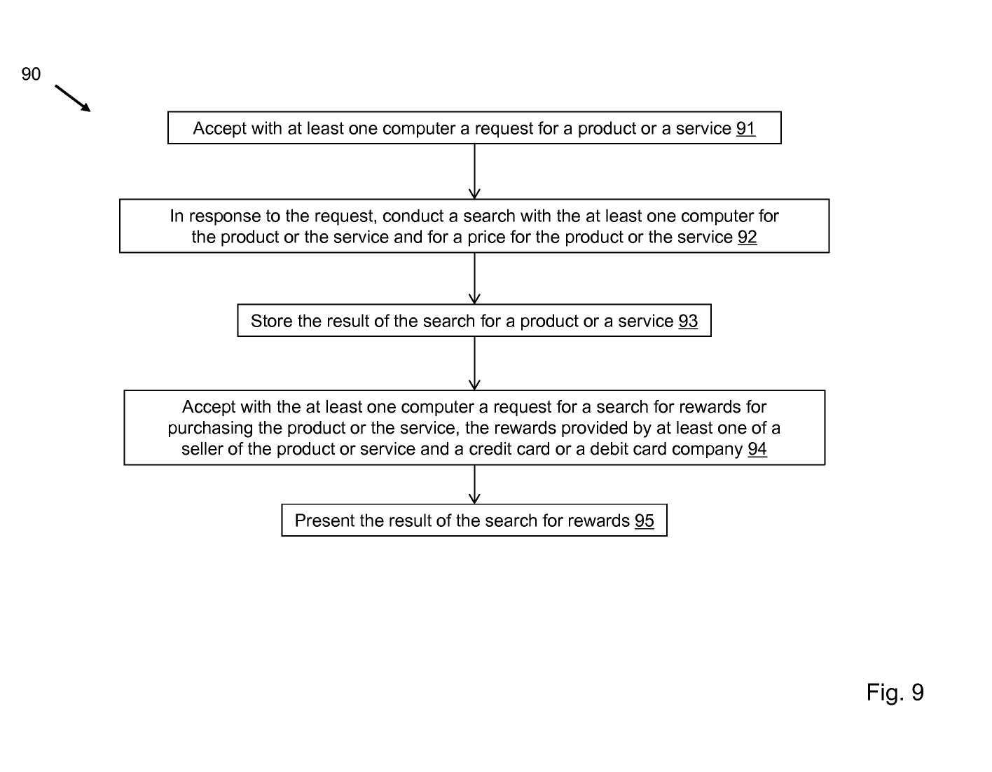

In another embodiment, as shown in the flowchart 90 of FIG. 9, one way to begin a method is to accept 91 with at least one computer a request for a price for a product or a service. In response to the request, the system may conduct 92 a search with the at least one computer for the product or the service, find the price for the product or the service and store 93 the result of the search. One may then conduct 94 with the at least one computer a search for rewards offers, or other incentive for purchasing the product or the service, the rewards provided through at least one of the seller of the product or the service and a financial services company, such as a credit card or debit card company. The results of the search may then be presented 95 to the user.

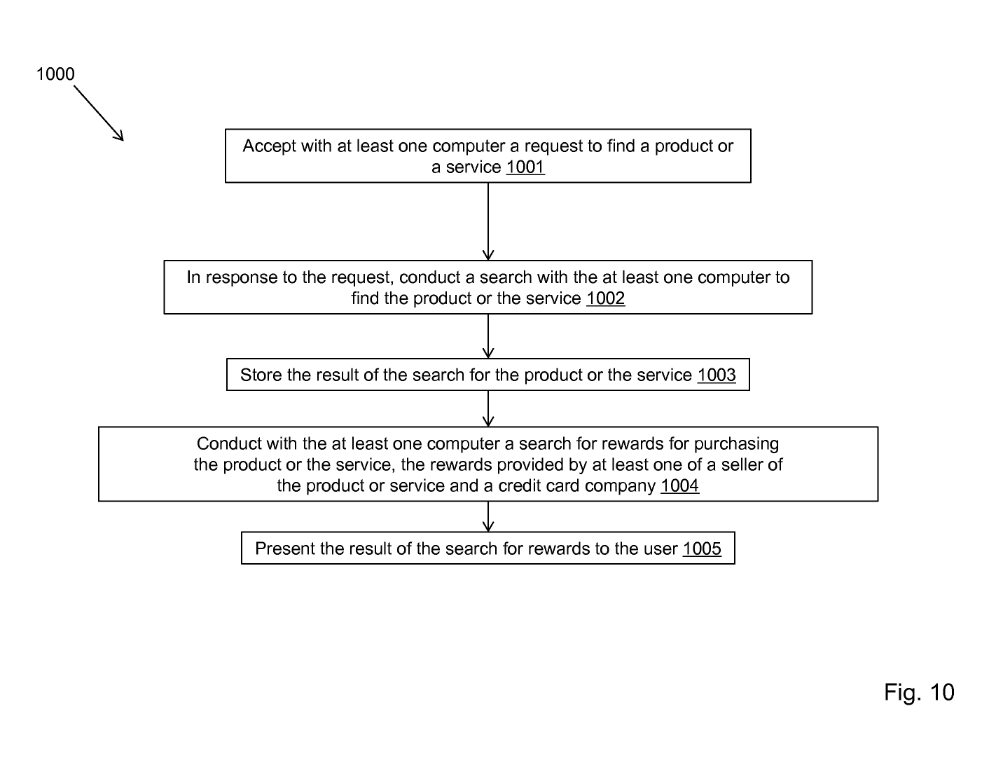

Yet another embodiment or example is depicted in FIG. 10. In this example, as shown in the flowchart 1000 of FIG. 10, one way to begin a method is to accept 1001 with at least one computer a request for a price for a product or a service. In response to the request, the system may conduct 1002 a search with the at least one computer for the product or the service, find the price for the product or the service and store 1003 a result of the search. One may then conduct 1004 with the at least one computer a search for rewards offers, or other incentive for purchasing the product or the service, the rewards provided through at least one of the seller of the product or the service and a credit card company. The results of the search may then be presented 1005 to the user.

In an embodiment, when a user goes through the purchase flow for an online purchase, at the checkout page, if the user has installed the browser plugin, they will be prompted to use the best card for this transaction, as identified by methods described herein. If the online store has done the integration based on the card the user has already saved with the retailer or the card the user has entered, the Javascript or API integration can suggest the best alternative card to use for this transaction.

In an embodiment, when the user goes through a purchase in-store, when the user swipes the card, based on one of the POS, Card Swipe, Payment Gateway or Authorization channel, the user may be notified to use an alternative card, such as either on the payment terminal or via mobile notification. When the user uses the in-store mobile payment application to pay for the purchase, the user can be notified to use an alternative card either, such as through a mobile API integration in the payment application, via mobile notification during authorization call, and the like.

In embodiments, various processes, methods, purchase flows and steps described herein may occur rapidly computationally. For example, the process flows described in any FIGS. 8-10 may occur on the order of seconds (e.g. 1 second, 2 seconds, 55 seconds, etc.), on the order of milliseconds (e.g. 200 ms, 100 ms, etc.) or microseconds (e.g. 900 microseconds, 750 microseconds, etc.), substantially instantaneously, and the like. Indeed, the processes, methods, purchase flows or steps may occur as quickly as enabled by the computational architecture executing the processes, methods, purchase flows and steps. The speed at which the processes, methods, purchase flows and steps can take place may impact the use, success or viability of the processes, methods, purchase flows and steps themselves. Users at a point-of-sale, for example, may only use the disclosed processes, methods, purchase flows or steps if they can be executed seamlessly and quickly during the course of a transaction. Indeed, the disclosed processes, methods, purchase flows or steps represent an improvement in the technology to enable real-time presentation of rewards, offers, or incentives and the processing of such rewards, offers, or incentives, either with or without the application of goals, preferences, rules, constraints, limitations, or filters, to assist a user in selecting a financial instrument with which to execute a transaction.

In embodiments, the processes, methods, purchase flows and steps disclosed herein may be executed on a distributed network architecture. For example, a portion of the process may take place at a point of sale computer where a user initiates the processes, methods, purchase flows or steps and may optionally input one or more preferences, limitations, filters or the like, then the processes, methods, purchase flows or steps may continue executing on a remote computer that may yet access other remote computers or databases to aggregate financial institutions data, offers, rewards, account statuses, and the like.

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include non-transitory memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, non-transitory memory, hard disk, flash drive, RAM, ROM, cache and the like.

A processor may include one or more cores that may enhance speed and performance of a multiprocessor. In embodiments, the processor may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, table computers, pad computers, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the disclosure has been disclosed in connection with the preferred embodiments shown and described in detail, various modifications and improvements thereon will become readily apparent to those skilled in the art. Accordingly, the spirit and scope of the present disclosure is not to be limited by the foregoing examples, but is to be understood in the broadest sense allowable by law.

All documents referenced herein are hereby incorporated by reference.

What is claimed is:

1. A method, comprising:
accepting with at least one computer a request from a user to find a product or a service;
in response to the request, conducting a search with the at least one computer for the product or the service;
storing a result of the search for the product or the service;
accepting a request with the at least one computer for a search for rewards for purchasing the product or service, the rewards provided by at least one of: a seller of the product or the service, a credit card company, and a debit card company; and
presenting the results of the search for rewards to the user.

2. The method of claim 1, wherein the request is made at a point-of-sale terminal of the seller.

3. The method of claim 1, further comprising notifying the user via a mobile device of the user that the user has an account with the seller or with a third-party service for additional rewards for the product or the service.

4. The method of claim 1, further comprising accepting the result of the search for the product or the service and rendering payment through a point-of-sale terminal of the seller.

5. The method of claim 1, further comprising accepting payment for the good or the service through a point-of-sale terminal of the seller of the product or the service, the payment rendered using a device selected the group consisting of a card swipe device of the seller, a near field communication (NFC) reader of the seller, a receiver for receiving communications from a wireless RFID fob of the user and a device for accepting a wireless payment communication from a wireless payment device or mobile device of the user.

6. The method of claim 1, further comprising accepting payment via the at least one computer by accepting information of a credit card or a debit card.

7. The method of claim 1, wherein the result of the search includes a reward offered through a third party marketing firm.

8. The method of claim 1, further comprising itemizing with the at least one computer the result of the search for rewards by a reward type, wherein the results of the search include a plurality of types of rewards, at least two of the plurality of types selected from the group consisting of: miles rewards, points rewards, cash back rewards, warranty-type rewards; travel-type rewards; discounts on future purchases from the seller; and insurance-type rewards.

9. The method of claim 1, wherein the search for the good or the service is conducted via the at least one computer accessible to a plurality of web sites of a plurality of sellers of the product or the service.

10. The method of claim 1, further comprising ranking the result of the search for rewards by a highest reward in at least one category of reward.

11. A method, comprising:
accepting with at least one computer a request to find a product or a service;
in response to the request, conducting a search with the at least one computer for the product or the service and for a price for the product or the service;
storing a result of the search;
accepting with the at least one computer a request for a search for rewards for purchasing the product or the service, the rewards provided by at least one of: a seller of the product or the service, a credit card company and a debit card company; and
presenting the result of the search for rewards.

12. The method of claim 11, further comprising ranking the results of the search for the product or the service according to a lowest price for the product or the service.

13. The method of claim 11, further comprising ranking the results of the search for rewards by a highest reward in a reward category.

14. The method of claim 11, further comprising ranking the results of the search for rewards by a highest reward in a reward category selected from the group consisting of: miles rewards, points rewards, travel-type rewards, and cash-back rewards.

15. The method of claim 11, further comprising ranking the results of the search for rewards by a combination of two or more types of rewards.

16. The method of claim 11, further comprising notifying a user via a mobile device of the user that the user is eligible for a reward from a merchant when the user enters a store of the merchant.

17. The method of claim 11, wherein the search for rewards comprises several searches of merchant, financial institution and credit card company web sites.

18. The method of claim 11, wherein the at least one computer comprises a mobile device of the user, and
further comprising, presenting the results to the mobile device of the user.

19. The method of claim 11, wherein the at least one computer comprises a point-of-sale terminal of a seller of the product of the service.

20. The method of claim 11, wherein at least one result from the search for rewards comprises discounts on future purchases made with the credit card or the debit card.

21. A method, comprising:
accepting with at least one computer a request from a user to find a product or a service;
in response to the request, conducting a search with the at least one computer for the product or the service;
storing a result of the search for the product or the service;
conducting with the at least one computer a search for rewards for purchasing the product or the service, the rewards provided by at least one of: the seller of the product or the service and a credit card company; and
presenting results of the search for rewards to the user.

22. The method of claim 21, further comprising presenting to the user at least one reward level or threshold that will be achieved depending on the credit card used by the user to purchase the product or the service.

23. The method of claim 21, further comprising presenting to the user a reward level or balance in at least two of: an account of the user with the seller of the product or the service; and credit card accounts of the user.

24. The method of claim 21, further comprising ranking at least one of the results of the search for the price for the product or the service to the user, or ranking the results of the search for rewards for purchasing the product or the service.

25. The method of claim 21, wherein the rewards are selected from the group consisting of miles rewards, points rewards, cash back rewards, warranty-type rewards, travel-type rewards; discounts on future purchases from the seller, and insurance-type rewards.

26. The method of claim 21, further comprising accepting a request via the at least one computer to a third party service to determine whether rewards are available for purchasing the product or the service.

27. The method of claim 21, wherein the results of the search for rewards includes a concierge service or access to a travel assistance service.

28. The method of claim 21, wherein the results of the search include a reward offered through a third party marketing firm.

29. The method of claim 21, wherein the seller of the product or the service offers the rewards for the purchasing the product or the service through an account or a private label credit card of the seller.
